(19) United States
(12) Patent Application Publication
(10) Pub. No.: US 2010/0003838 A1
(43) Pub. Date: Jan. 7, 2010

(54) BURN-IN SOCKET

(75) Inventors: JIA-JIA CAI, Shenzhen (CN); QUAN WANG, Shenzhen (CN); ZHEN-QI YANG, Shenzhen (CN); FU-JIN PENG, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/495,826

(22) Filed: Jul. 1, 2009

(30) Foreign Application Priority Data
Jul. 1, 2008 (CN) 200820301383.6

(51) Int. Cl. H01R 12/00

(52) U.S. Cl. 439/73

(57) ABSTRACT

A burn-in socket includes a base, a sliding plate mounted to the base and having a number of pin holes, a number of contacts secured to the base and an actuator mounted on the base. The contacts each comprise a base portion and a pair of arms received in the pin holes of the sliding plate. The actuator includes a frame and a number of actuating portion for driving the sliding plate to move in a transversal direction. The actuating portion has a protrusion at a top end thereof and the protrusion makes the sliding plate not only open one of the pair of arms, but also push a solder ball received in the pair of arms away from the other one of the pair of arms.

### BACKGROUND OF THE INVENTION

1. Field of the Invention

The present invention relates to a burn-in socket, and more particularly to a burn-in socket mounted on a printed circuit board (PCB) for receiving and testing an IC package.

2. Description of Prior Art

Central Processing Unit (CPU) and other electrical package, generally referred to as IC package, are undergone a test simulating its real working environment so as to make sure its functions from all intended ranges.

A conventional burn-in socket typically comprises a base, a plurality of contacts disposed on the base, latches, a sliding plate for driving the contacts, and an actuator for actuating the latches and the sliding plate. The contact each has a pair of arms inserted into the sliding plate and one is stationary, the other is moveable. When pressing the actuator and driving the sliding plate to move in a transversal direction and further make the moving arm away from the stationary arm to create a space therebetween, a solder ball of the IC package can be disposed in between the pair of arms. When the actuator is released, the moving arm will close toward the stationary arm and sandwich the solder ball therebetween. When the test is over completed, since the solder ball is soft, which cause sharp point of the stationary arm pierces into and solder ball, and stuck there. Once the stationary arm is stuck, firstly, the IC package can not be readily removed therefrom, and secondly, it is most likely the solder ball is removed from the IC package.

Thus, there is a need to provide an improved burn-in socket to overcome the above-mentioned problems.

### SUMMARY OF THE INVENTION

An object of the present invention is to provide a burn-in socket for facilitating to pick up an IC package and protecting the contacts and the IC package.

In order to achieve the object set forth, a burn-in socket comprises a base, a sliding plate, a plurality of contacts and an actuator. The sliding plate is mounted to the base and having a plurality of pin holes. The contacts each comprise a base portion secured to the base and a pair of arms extending upwardly from the base portion and received in the pin holes of the sliding plate. The actuator is mounted on the base and includes a frame and a plurality of actuating portion extending downwardly form the frame for driving the sliding plate to move in a transversal direction. The sliding plate opens the pair of arms when driven. The actuating portion has a protrusion at a top end thereof and the protrusion makes the sliding plate further to move further away to increase the space between the arms.

### BRIEF DESCRIPTION OF THE DRAWINGS

Other objects, advantages and novel features of the present invention will become more apparent from the following detailed description when taken in conjunction with the accompanying drawings, in which:

FIG. 1 is an assembled, perspective view of a burn-in socket in accordance with a preferred embodiment of the present invention;

FIG. 2 is an exploded, perspective view of the burn-in socket shown in FIG. 1;

FIG. 3 is a perspective view of a contact of the burn-in socket shown in FIG 2;

FIG. 4 is a side view of the actuator and the sliding plate of the burn-in socket;

FIG. 5 is a sketch view showing the stationary arm and the moving arm are clipping a solder ball;

FIG. 6 is a sketch view showing a moving arm of another contact of the burn-in socket is pushing the solder ball; and

FIG. 7 is a sketch view showing the solder ball has been pushed away from the stationary arm.

### DESCRIPTION OF PREFERRED EMBODIMENT

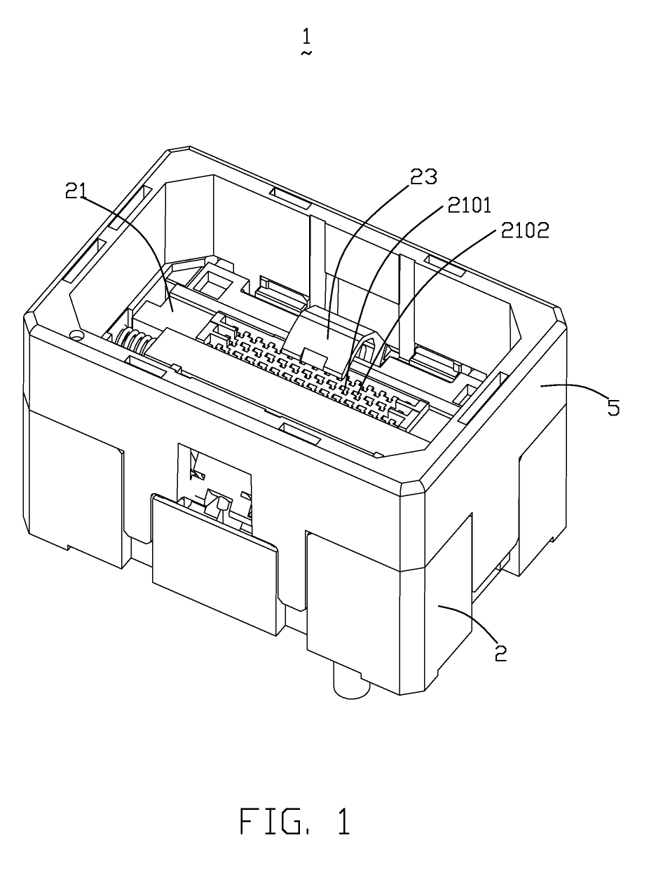

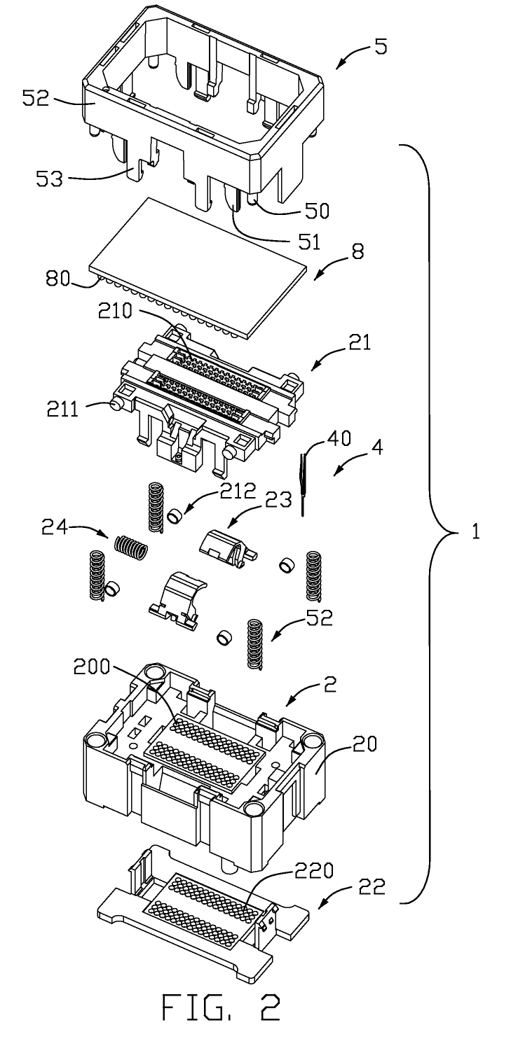

Referring to FIGS. 1-2, a burn-in socket 1 in accordance with a preferred embodiment of the present invention is generally mounted to a printed circuit board (not shown) to receive and test an IC package 8. The burn-in socket 1 includes a socket body 2, a plurality of contacts 4 mounted to the socket body 2, and an actuator 5 movably mounted upon the socket body 2. The IC package 8 is put into the socket body 2 to be tested.

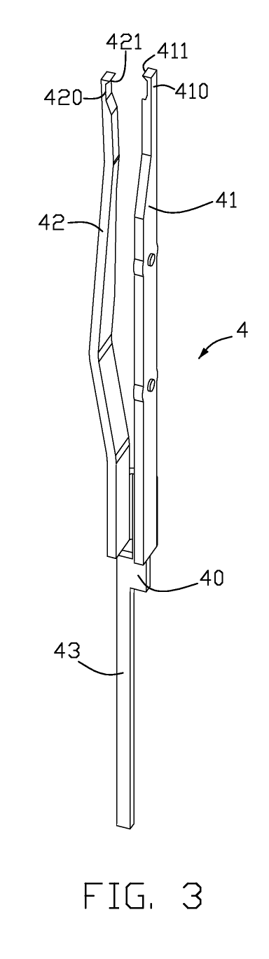

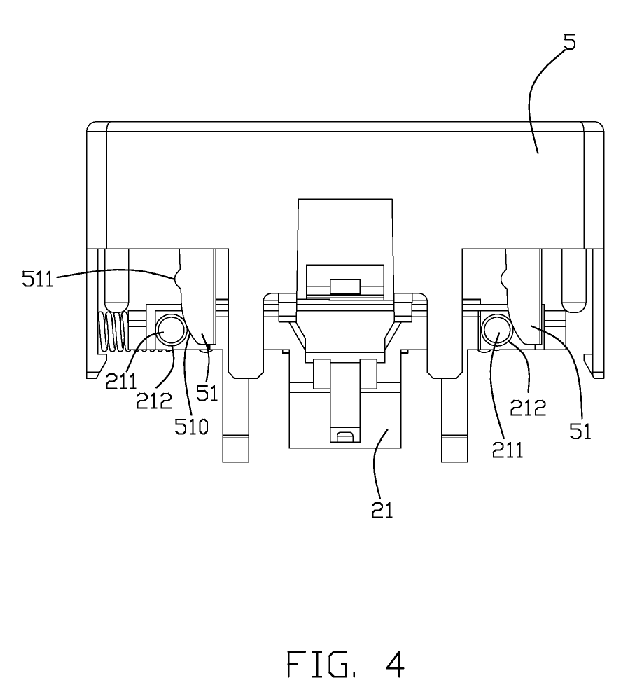

Referring to FIGS. 3-4, the contact 4 includes a middle base portion 40, a pair of testing arms respectively extending upwardly from the base portion 40, and a tail portion 43 extending downwardly from the base portion 40. The pair of testing arms includes a fixed ram 41 with a linear configuration and a moving arm 42 movable relative to the stationary arm 41. The top ends of the testing arms are respectively formed with tip portions 410, 420 so as to jointly clip one solder ball 80 of the IC package 8. The tip portions 410, 420 respectively have a claw 411, 421 toward each other to claw an oxide layer formed on an outer surface of the solder ball 80.

Particularly referring to FIGS. 2-4, the socket body 2 includes a base 20, a sliding plate 21 capable of reciprocating along the base 20, a bottom plate 22 fixed to bottom side of the base 20, and a pair of locking elements 23 to jointly lock the IC package 8 loaded on the sliding plate 21. The bottom plate 22, the base 20, and sliding plate 21 respectively define a plurality of pin holes 220, 200, 210, extending therethrough for the contacts 4 passing through one by one. The base portion 40 is retained in the pin holes 200 of the base 20, and the tip portions 410, 420 extend out of the pin holes 210 of the sliding plate 21, while the tail portion 43 extends downwardly out of the pin hole 220 of the bottom plate 22.

The sliding plate 21 slides transversally by the actuation of the actuator 5. The sliding plate 21 has an axis 211 received in a roller 212 for mating with the sliding plate 21. The sliding plate 21 is equipped with a spring 24 with one end thereof abutting against the sliding plate 21 and the other end abutting against the base 20, thereby driving the sliding plate 21 back to its original position after the transversal movement.

Each pin hole 210 of the sliding plate 21 includes of a first hole 2101 for receiving the stationary arm 41 and a second hole 2102 for receiving the moving arm 42′. The first hole 2101 is longer than the second hole 2102 so that the stationary arm 41 can't move respect to the base 20 and the moving arm 42 move away from the stationary arm 41. Please be noted, in the preferred embodiment of the present intention, the same pin hole 210 receives a stationary arm 41 of one contact and a moving arm 42′ of a neighboring contact of the other contact.

The actuator 5 has a main frame 52, two pair of latches 53 for positioning the actuator 5 on the base 2, four posts 50 extending downwardly from the frame 52, and an actuating portion 51 extending downwardly from the frame 52 for driving the sliding plate 21. The actuating portion 51 has an actuating section 510 with an arc shape for contacting with the roller 212 of the sliding plate 21 and a protrusion 511 at a top end of the actuating section 510. When the actuator 5 is pressed, the actuating section 510 engages with the roller 212 and further drives the sliding plate 21 to move. The sliding plate 21 urges the moving arm 42 received in the pin holes 210 to move away from the stationary arm 41.

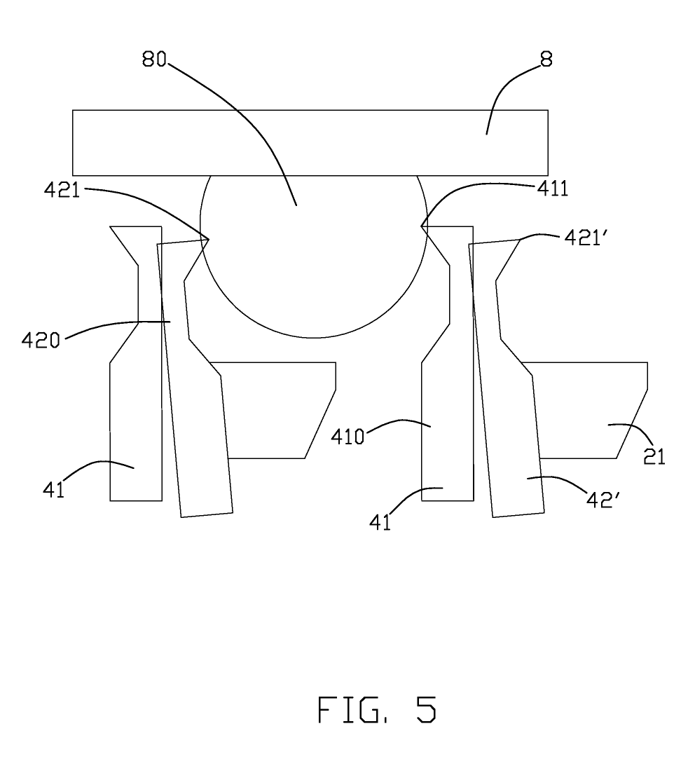

The moving and stationary arms 41, 42 are spaced from each other and the two locking elements 23 turn to an opened state when the actuator 5 is in a lower position. In this situation, the IC package 8 is easy to be easily placed into the socket body 2 or to be taken out of the socket body 2. As the actuator 5 is turned to an original position, the moving and stationary arms 41, 42 move closer to each other and jointly and tightly clip the solder ball 80 of the IC package 8 as shown in FIG. 5, while the locking elements 23 are pressed on the IC package 8. It's a known technology concerning to the configuration of the sliding plate 21 and the principles about how to actuate the contacts 4, and will not be specifically described herein. Besides, a spring 52 is provided between the actuator 5 and the socket body 2 so as to reset the actuator 5 after its downward movement.

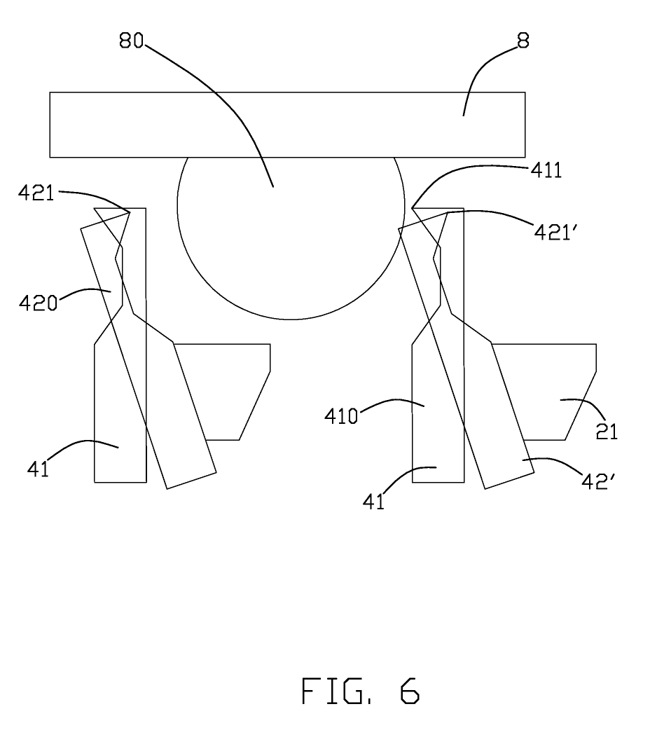

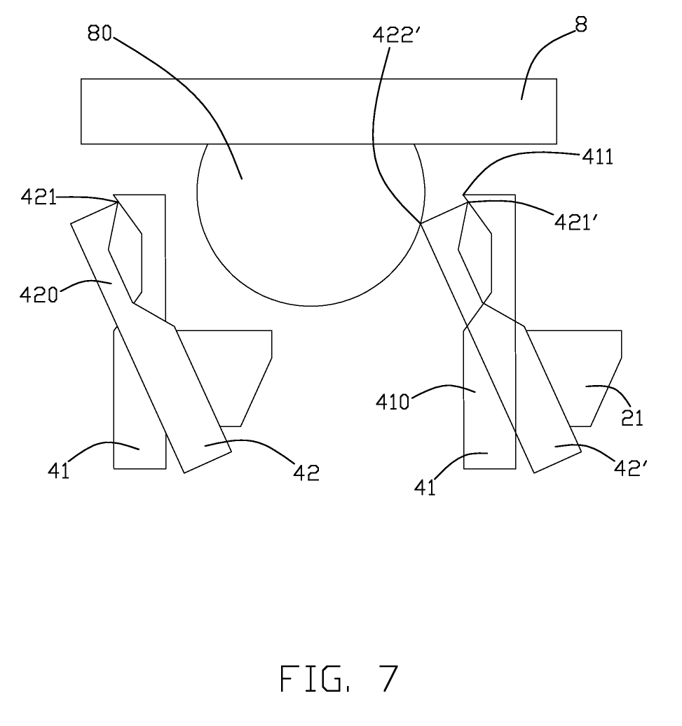

When the IC package 80 is received in the burn-in socket 1, when the test is over, the solder ball 80 is soft so as to stick the claw 411 of the stationary arm 41 of the contact 4. The contact section 510 is provided with the protrusion 511 whereby the displacement of the moving arm 42 is increased. Since each contact is closed to a neighboring one, and the contacts 4 can be arranged in a predetermined pattern, the solder ball 80 received in a contact can be pushed upward by a stationary arm 42′ of a neighboring contact 4. FIG. 6 shows the actuator 5 is in a compressed position, it can be seen the claw 421′ of the neighboring contact 4 contacts with the solder ball 80. Since the movement path of the sliding plate 21 and the moving arm 42 is increased by providing the protrusion 511, the moving arm 42′ exerts force on the solder ball 80 and separated the solder ball 80 from the stationary arm 41 as shown in FIG. 7. Therefore, the IC package is easily to be released without damaging the contact 4 and solder ball 80.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. A burn-in socket comprising:
a base;
a sliding plate mounted to the base and having a plurality of pin holes;
a plurality of contacts each comprising a base portion secured to the base and a pair of arms extending upwardly from the base portion and received in the pin holes of the sliding plate; and
an actuator mounted on the base and including a frame and a plurality of actuating portion extending downwardly form the frame for driving the sliding plate to move in a transversal direction, wherein the movement of the sliding plate opens the pair of arms widely, and the actuation portion includes a protrusion at a top thereof to all the sliding plate to move further to include the space between the arms.

2. The burn-in socket as claimed in claim 1, wherein two sides of the sliding plate respectively has a mating portion engaging with the contacting portion and the protrusion of the actuator.

3. The burn-in socket as claimed in claim 2, wherein the mating portion includes an axis and a roller for receiving the axis.

4. The burn-in socket as claimed in claim 1, wherein the actuating section is arc shape, and the protrusion projects from actuating section in the transversal direction.

5. The burn-in socket as claimed in claim 1, wherein the actuator moves relative to the base in a vertical direction.

6. The burn-in socket as claimed in claim 1, wherein each contact comprises a stationary arm and a moving arm, and the sliding plate drives the moving arm relative to the stationary arm.

7. The burn-in socket as claimed in claim 6, wherein the burn-in further comprising a pair of locking elements, and the locking elements lock an IC package loaded on the sliding plate.

8. A burn-in socket for testing an IC package with solder balls, comprising:
a base;
a sliding plate mounted to the base and having a plurality of pin holes;
a plurality of contacts each comprising a base portion secured to the base and a pair of arms extending upwardly from the base portion and received in the pin holes of the sliding plate, first and second contacts disposed within the housing in such a manner that a first moveable arm of the first contact extends adjacent to the second stationary arm of the second contact so as for ejecting a solder ball in contact with the second stationary arm; and
an actuator mounted on the base and including a frame and a plurality of actuating portion extending downwardly form the frame for driving the sliding plate to move in a transversal direction;
the pair of arms including a stationary arm and a moving arm for sandwiching a solder ball therein, the sliding plate driving the moving arm of one contact away from the solder ball and the moving arm of the other contact to push the solder ball away from the stationary arm of said one contact.

9. The burn-in socket as claimed in claim 8, wherein the actuating portion of the actuator defines a protrusion at a top end thereof for driving the moving arm of the other contact to push the solder ball.

10. The burn-in socket as claimed in claim 9, wherein the actuating section is arc shape and the protrusion is projects from the actuating section in the transversal direction.

11. The burn-in socket as claimed in claim 10, wherein two sides of the sliding plate respectively has a mating portion engaging with the actuating portion and the protrusion of the actuator.

12. The burn-in socket as claimed in claim 8, wherein the actuator move relative to the base in a vertical direction.

13. The burn-in socket as claimed in claim 8, wherein the burn-in further comprise a pair of locking elements, and the locking elements lock an IC package loaded on the sliding plate.

14. The burn-in socket as claimed in claim 8, wherein each pin hole includes a first hole for receiving the stationary arm and a second hole for receiving the moving arm, and the stationary arm and the moving arm received in the same pin hole belong to different contacts.

15. A burn-in socket assembly comprising:
an insulative housing;
a plurality of contacts disposed in the housing, each of said contacts including opposite first and second contacting arms, at least the first contacting arm being a moveable contacting arm and moveable relative to the second contacting arm to enlarge a space between said first and second contacting arms;
a BGA type electronic package having a plurality of conductive balls respectively contacting said pair of contacting arms; wherein
in a mating condition each of said balls is sandwiched between the corresponding first and second contacting arms while in a un-mating condition each of said balls is disengaged from both said first and second contacting arms but abutted against by another moveable contacting arm of the neighboring contact to have the ball leave the second contacting arm.

16. The burn-in socket assembly as claimed in claim 15, wherein said second contacting arm is immoveable.

17. The burn-in socket assembly as claimed in claim 15, wherein said moveable contacting arm is pushed to move by a plate.

18. The burn-in socket assembly as claimed in claim 16, wherein said plate is moved horizontally.

19. The burn-in socket assembly as claimed in claim 15, wherein said neighboring contact is located closer to the second contacting arm than to the first contacting arm.
